(19) United States
(12) Patent Application Publication
(10) Pub. No.: US 2024/0197108 A1
(43) Pub. Date: Jun. 20, 2024

(54) Food Processor, Food Preparation Method, Computer Program Product and Storage Medium

(71) Applicant: Vorwerk & Co. Interholding GmbH, Wuppertal (DE)

(72) Inventor: Andreas Uhlenbrock, München (DE)

(21) Appl. No.: 18/538,427

(22) Filed: Dec. 13, 2023

(30) Foreign Application Priority Data
Dec. 20, 2022 (EP) 22 215 029.4

(51) Int. Cl. A47J 36/32

(52) U.S. Cl. CPC A47J 36/32; A47J 37/0623

(57) ABSTRACT

The invention relates to a food processor (10) configured and adapted to electronically accessing a recipe (11) and processing the recipe (11) for performing a food preparation comprising multiple preparation steps/stages (12), performing comparisons between target working times (t1-t7) predetermined in the recipe (11) for performing the preparation steps/stages (12) and actual working times actually required by a user of the food processor (10) for performing the preparation steps/stages (12), determining at least one speed factor (f1; f2; f3, f4; f5) relating to a working speed of the user on the basis of the comparisons carried out, and determining at least one future target working time for performing at least one future preparation step/stage (12) on the basis of a predetermined target working time and the at least one determined speed factor (f1; f2; f3, f4; f5). The invention further relates to a method for food preparation with the food processor (10), a computer program product (14) for performing the method, and a storage medium (15) on which the computer program product is stored.

The present invention relates to a food processor, a method of food preparation using a food processor, a computer program product for performing such method, and a computer readable storage medium on which such computer program product for executing the method is stored.

In the prior art, food processors are known that can access digital recipes for automated food preparation. Access to the recipes or to a desired recipe usually takes place electronically after a user of the food processor has manually selected a particular recipe. To prepare the desired food, the user can work successively through various preparation steps/stages in a sequence specified in the recipe—comparable to cooking according to a recipe in a cookbook. Generic food processors can perform preparation steps/stages in an automated or at least partially automated manner, based on the present recipe. Inputs and/or activities by the user may be required between automated preparation steps/stages.

It is an object of the present invention to provide an improved system as well as an improved method for food preparation.

The foregoing object is solved by the claims. In particular, the foregoing problem is solved by the food processor according to the independent device claim, the method according to the independent method claim, the computer program product according to the independent computer program product claim, and the storage medium according to the independent storage medium claim. Further advantages of the invention result from the dependent claims, the description and the figures. In this context, features described in connection with the food processor naturally also apply in connection with the method according to the invention, the computer program product according to the invention, the storage medium according to the invention, and vice versa in each case, so that reference is and/or can always be made mutually with regard to the disclosure concerning the individual aspects of the invention.

According to a first aspect of the present invention, a food processor is proposed which is configured and adapted to:
electronically accessing a (digital) recipe and processing the recipe (in the food processor) to perform a food preparation with multiple preparation steps/stages,
performing comparisons between target working times specified in the recipe for performing the preparation steps/stages and actual working times actually required by a user of the food processor for performing the preparation steps/stages,
determining at least one speed factor relating to a working speed of the user on the basis of the comparisons made, and
determining at least one future target working time for performing at least one future preparation step/stage on the basis of a predetermined target working time and the at least one determined speed factor.

In the food processor according to the invention, recipes are stored, in particular digitally as a data record within a memory, which can be processed, preferably automatically, by a control device through various work steps/stages carried out by the food processor. By the control device may be understood a central control device of the food processor. Additionally, or alternatively, the food processor may be configured and adapted such that the various work steps/stages are processable based on information from a network, for example the Internet. In this way, a user can operate the food processor via the Internet, for example a cloud function. Consequently, the food processor may be configured and adapted as a network food processor and/or a food processor with Internet access, in particular with wireless Internet access. For wireless internet access, the food processor may include a suitable wireless transmitter/receiver. Accordingly, recipes may be stored in the food processor and/or on the Internet, for example in a cloud environment. The food processor may be configured and adapted for online access to the recipes and/or for modifying the recipes stored online. The recipes are selectable and retrievable by a user preferably through an input apparatus of the food processor. Furthermore, the food processor has at least one device function (e.g., stirring, weighing, cooking, or the like) that is selectable and/or adjustable by at least one parameter to automatically perform at least the (or one) work step/stage from the recipe for a preparation of a food (food preparation) by the respective device function of the food processor. This work step/stage represents a preparation step/stage which is carried out by the food processor (itself).

With the food processor according to the invention, the (digital) recipe and in particular future target working times can be changed dynamically during food preparation depending on previous and/or currently detected user behavior. In contrast to conventional food processors, therefore, not only static values or values already stored in the recipe are used to determine and plan food preparation. If, during food preparation and/or during a past food preparation, it is recognized on the basis of the comparisons that the actual working time of the user was approximately 10% longer than the specified target working time for each preparation step/stage or for certain preparation steps/stages, the future target working times can be adjusted accordingly. This means that a speed factor with the value 1.1 could be determined or created, with which the target working times specified or stored in the recipe so far and still to be performed can be multiplied. In this way, precise future target working times can be determined, with which the recipe can be adjusted to the working speed of the user quickly, precisely and in particular during the food preparation. On the basis of the adjusted working time, food preparation can also be continuously optimized.

The comparison between the target working times specified in the recipe and the actual working times actually required by the user of the food processor can be carried out at least partially automatically and/or automated by the food processor. For this purpose, the food processor may have a suitable sensor system, actuator system and/or computing device. The sensor system may comprise at least one sensor for detecting a transition from one preparation step/stage to the next preparation step/stage and/or for detecting a start as well as an end of the respective preparation steps/stages. The at least one sensor can be in signal connection with the computing device, so that the computing device can determine, in particular calculate, the duration of the respective working steps/stages or the respective actual working times on the basis of the determined sensor data. By performing the comparisons automatically, the economic effort for the comparisons can be kept low and the food processor can be operated efficiently.

The sensor system, the actuator system and/or the computing device, which may be provided as part of a control device of the food processor, may be configured and adapted for electrically accessing the recipe, for processing the recipe, for determining the actual working times, for determining the at least one speed factor and/or for determining the at least one future target working time. The electronic accessing and a corresponding electronic processing of the recipe may be performed, for example, through the control device of the food processor. The at least one speed factor and the at least one future target working time can be determined and/or calculated in particular through the computing device, which can be considered as part of the control device, and through suitable sensor data.

Future target working times are in particular target working times for the preparation steps/stages to be performed by the user or the corresponding work steps/stages that have not yet been performed and still have to be performed to complete the dish or to complete the food preparation. These future preparation steps/stages can be understood in particular as a still outstanding part of preparation steps/stages during the food preparation. In principle, however, the future preparation steps/stages can also be understood as all preparation steps/stages of a new or future food preparation.

The preparation steps/stages for which the comparisons are made with regard to the future target working times include, in particular, preparation steps/stages to be performed manually by the user, i.e., manual preparation steps/stages in which the user himself must be active. For example, a preparation step/stage can be understood as the cutting of food, the washing of food and/or the transfer of food from one vessel to another vessel.

According to a further embodiment of the present invention, it is possible that a food processor according to the present invention is configured and adapted in such a way that, on the basis of the at least one speed factor and/or on the basis of the at least one determined future target working time, an end time of the food preparation and/or a remaining time duration until the end time is reached are determined and displayed in a manner perceptible to the user. Taking into account the at least one determined future target working time or taking into account the previous working mode of the user and implementing the knowledge gained on the preparation steps/stages still to be carried out and the time which is expected to be required for this, the presumably remaining working time or remaining time duration and correspondingly also the end time of the food preparation can be determined relatively accurately in a simple manner and displayed perceptibly for the user. The end time of the food preparation is to be understood in particular as a time at which the dish is expected to be finished. The end time may further be determined on the basis of a current time. In the context of the invention, determining on the basis of a certain information such as the speed factor and/or the future target working time is to be understood as determining in which not only this information(s) must be used, but also further information and/or parameters can be used and/or taken into account. The food processor may further be configured and adapted such that, based on the at least one speed factor and/or based on the at least one determined future target working time, the total duration of food preparation is determined and displayed in a manner perceptible to the user. The end time of the food preparation can be set depending on the current time and displayed accordingly perceptibly for the user.

A food processor according to the invention can further be configured and adapted such that the at least one future target working time is determined during food preparation and/or is displayed perceptibly to the user during food preparation. That is, after the future target working time has been determined, it is preferably stored in the recipe and can be displayed to the user accordingly without delay. For this purpose, the original target working time or the target working time originally specified in the recipe can be changed or a new target working time can be created. In this way, the user of the food processor can always be informed about the remaining and/or necessary time for food preparation or for the individual preparation steps/stages both dynamically and, correspondingly, accurately. Accordingly, the future target working times can not only be determined dynamically, but can also be displayed in a correspondingly perceptible manner for the user. Furthermore, it is possible that the food processor has an input device for manual and/or voice-controlled changing of the future target working times. For displaying the recipe as well as possible changes in the recipe, in particular with regard to the target working times, a remaining duration and/or an end time, the food processor may have a display device, in particular an indication device. The indication device, for example adapted as part of a user interface, preferably has a touch display, via which not only data can be read, but also data can be entered by the user. The display device can be understood as a device for visual and/or acoustic display of information. Accordingly, target working times can be displayed not only visually but also acoustically, in particular through voice output. The same applies analogously to other information that can be displayed acoustically and/or visually.

A food processor according to the invention may further be configured and adapted such that the future target working time is determined for performing at least one future manual preparation step/stage, in particular exclusively for performing the at least one future manual preparation step/stage. In other words, it is possible that the future target working time is determined only for manual preparation steps/stages and not for automatic and/or autonomous preparation steps/stages that are performed by the food processor itself without participation of the user. In this way, the computing process in the food processor can be configured efficiently and the food processor can be operated with corresponding performance and power savings.

Furthermore, according to a variant of the present invention, it is possible for a food processor to be configured and adapted such that an average speed factor with respect to an average working speed of the user is determined on the basis of the comparisons, and the at least one future target working time for performing the at least one future preparation step/stage is determined on the basis of a predetermined target working time and the determined average speed factor. In other words, based on at least two comparisons performed, an average deviation of the actual working time from the target working time can be determined, from which in turn the average speed factor can be derived. If, for example, the speed factors 1.1 and 1.3 were determined on the basis of the comparisons, the average speed factor can be set to 1.2. The calculation or determination of the average speed factor can be carried out across tasks or task-specifically. This means that if, for example, an average speed factor of 1.1 is determined for cutting vegetables and an average speed factor of 1.3 is determined for washing fruit, an average speed factor of 1.2 can be determined for all future manual preparation steps/stages, i.e. across tasks or regardless of the type of preparation steps/stages. In a task-specific determination of the average speed factor, an average speed factor of 1.2 can be determined for the cutting of vegetables if, for example, 1.1 was determined twice and 1.3 was determined twice and 1.2 was determined once in multiple comparisons regarding the cutting of vegetables. Other speed factors and/or average speed factors can then be used for other tasks or for preparation steps/stages of other types. The food processor may further be configured and adapted such that, based on a determined deviation from the average working speed, for example due to a distracted user, the end time of food preparation and/or the remaining time duration until the end time is reached are determined and displayed in a manner perceptible to the user. This means, for example, if it is detected that the user needs longer for a preparation step/stage than expected or determined on the basis of the average speed factor, the end time can be shifted backwards and/or the displayed remaining time duration can be extended accordingly. The same applies in an analogous manner for the case that the user completes the preparation steps/stages faster than expected or assumed on the basis of the average speed factor. Using the average speed factor, a calculation process for determining the at least one future target working time can be executed, particularly, efficiently.

Furthermore, in a method according to the present invention, it is possible that a food processor is configured and adapted in such a way that, on the basis of the comparisons, different specific speed factors are determined with respect to a respective working speed for different preparation steps/stages and the at least one future target working time for performing the at least one future preparation step/stage is determined on the basis of a specific speed factor. That is, through the different or specific speed factors, the target working times for different future preparation steps/stages can be determined differently. In this way, the future target working times can be determined or predicted particularly accurately. If, for example, it is determined on the basis of the comparison that the user always needs approx. 20% longer to wash foodstuffs than is provided according to the target working time, but the actual working time for mixing ingredients is always approx. 10% faster than the target working time specified for this, this can be taken into account accordingly for the following preparation steps/stages, in which foodstuffs may have to be washed again and/or ingredients may have to be mixed. In this case, the target working time for washing food could be multiplied by a speed factor of 1.2, whereas the target working time for mixing ingredients could be multiplied by a speed factor of 0.9.

A food processor according to the invention can further comprise a profile memory for storing different user profiles of different users of the food processor, wherein the food processor can be configured and adapted such that different speed factors of different users are assigned to the respective user profile and the at least one future target working time is determined on the basis of at least one user-specific speed factor from the user profile used for food preparation. In this way, the at least one future target working time can always be displayed and/or predicted as precisely as possible to the user even if the food processor is used by different users. The different user profiles can be created by the users themselves or by the food processor, for example using artificial intelligence. As soon as the food processor is used, i.e. even before the recipe is selected and/or food preparation is started, the user can retrieve or set his user profile stored in the food processor. Based on the user profile now available for the food preparation, the food processor and in particular a control device of the food processor can now use the corresponding speed factors for the respective user. That is, for example, if the user profile of the experienced cook “Grandpa” is selected, the at least one future target working time can be determined on the basis of a speed factor of 0.8 and set and displayed accordingly. If the user profile of “Daughter” is selected, the at least one future target working time can be determined using a speed factor of 1.5, for example, and set and displayed accordingly. If the user profile of “Dad” is selected, for example, the future target working time for washing food can be determined using a speed factor of 0.9 and set and displayed accordingly. Furthermore, it is of course possible that even when using user profiles, the at least one future target working time can still be changed during food preparation. The profile memory can be understood as an appliance memory of the food processor. Furthermore, it is possible that the memory is provided as a decentralized memory, for example in a network and/or in a cloud environment, to which the food processor and in particular the control device of the food processor has access. The food processor and/or the control device of the food processor may further be configured and adapted for actively accessing information and/or data in the cloud environment and for processing this data.

Another aspect of the present invention relates to a method, in particular a computer-implemented and/or computer-implementable method, for food preparation using a food processor as described above, comprising:
electronically accessing a recipe and processing the recipe to perform food preparation with multiple preparation steps/stages,
performing comparisons between target working times specified in the recipe for performing the preparation steps/stages and actual working times actually required by a user of the food processor for performing the preparation steps/stages,
determining at least one speed factor relating to a working speed of the user on the basis of the comparisons made, and
determining at least one future target working time for performing at least one future preparation step/stage on the basis of a predetermined target working time and the at least one determined speed factor.

Thus, the method according to the invention brings the same advantages as have been described in detail with reference to the food processor according to the invention. Within the scope of the method, it is further possible that, on the basis of the at least one speed factor and/or on the basis of the at least one determined future target working time, an end time of the food preparation and/or a remaining time duration until the end time is reached are determined and displayed in a manner perceptible to the user. Furthermore, it is possible that the at least one future target working time is determined during food preparation and/or is displayed perceptibly to the user during food preparation. Based on the comparisons, an average speed factor with respect to an average working speed of the user can be determined, in particular continuously determined, wherein the at least one future target working time for performing the at least one future preparation step/stage can be determined based on a predetermined target working time and the determined average speed factor. Furthermore, it is possible that different specific speed factors with respect to a respective working speed for different preparation steps/stages are determined on the basis of the comparisons and the at least one future target working time for performing the at least one future preparation step/stage is determined on the basis of a specific speed factor. Furthermore, different speed factors of different users can be assigned to a respective user profile stored in the food processor, and the at least one future target working time can be determined on the basis of at least one user-specific speed factor from the user profile used for food preparation. If the food processor is adapted as a network food processor or as a food processor with Internet access, it is possible that the at least one determined speed factor and/or the at least one determined future target working time are uploaded to the Internet, for example a cloud environment. In this way, these data can be made available to multiple users of multiple food processors simultaneously. Furthermore, it is possible that the at least one speed factor and/or the at least one future target working time are determined at least partially on the Internet, for example in a cloud environment. For example, values determined by sensors of the food processor can be uploaded to the Internet and processed there to obtain the desired information. In this way, the method can still be performed in a performant manner even if the computing power of the food processor itself is low and/or the corresponding computing device of the food processor is outdated. The data and information determined in the manner described herein, such as the at least one speed factor and/or the at least one future target working time, can be stored in meta-data of the recipe. For performing the method, this meta-data may also be accessed when accessing the recipe. The food processor may be configured and adapted to perform the respective method steps/stages.

Another aspect of the invention relates to a computer program product comprising instructions which, when the computer program product is executed by a computer, cause the computer to execute the method described above. Furthermore, the invention relates to a computer-readable and, in particular, non-volatile storage medium on which a computer program product as described above is stored. Thus, the computer program product according to the invention as well as the storage medium according to the invention also provide the advantages described above.

The computer program product may be implemented as computer-readable instruction code in any suitable programming language and/or machine language, such as JAVA, C++, C#, and/or Python. The computer program product may be stored on a computer-readable storage medium such as a data disk, a removable drive, volatile or non-volatile memory, or a built-in memory/processor. The instruction code may program a computer or other programmable device, such as a control device, in such a manner as to execute the desired functions. Further, the computer program product may be provided and/or be on a network, such as the Internet, from which it may be downloaded by a user as needed. The computer program product may be and/or be implemented through software, as well as through one or multiple special electronic circuits, that is/are realized, in hardware or in any hybrid form, that is/are realized, through software components and hardware components.

Further measures improving the invention will be apparent from the following description of various embodiments of the invention, which are shown schematically in the figures. All features and/or advantages arising from the claims, the description or the figures, including constructional details and spatial arrangements, may be essential to the invention both individually and in the various combinations.

It shows schematically in each case:

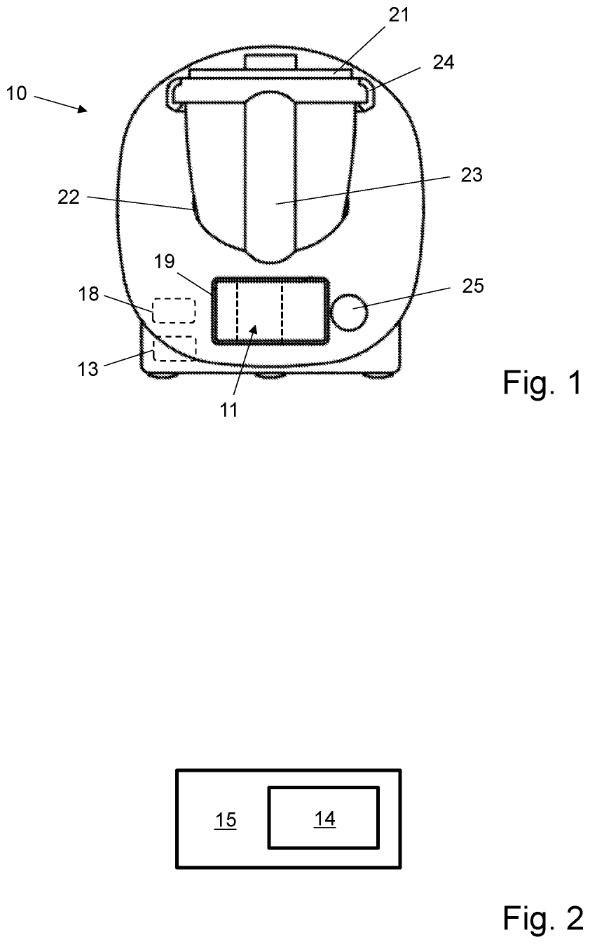

FIG. 1A food processor according to one embodiment of the present invention,

FIG. 2A computer readable storage medium having a computer program product stored thereon in accordance with one embodiment of the present invention,

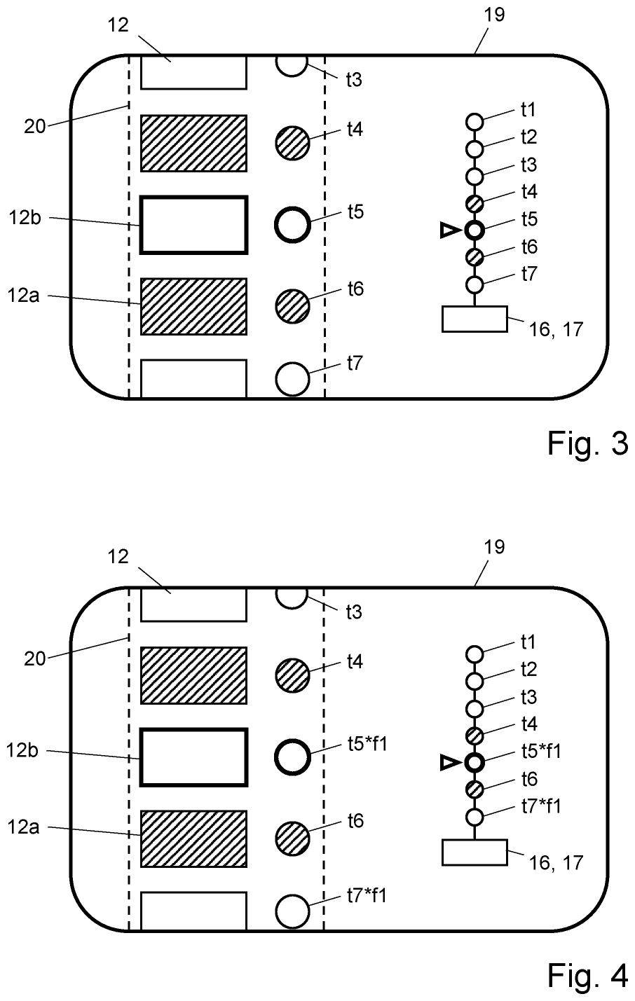

FIG. 3A user interface of a food processor according to a conventional configuration,

FIG. 4A user interface for explaining a first configuration variant of the food processor according to the invention,

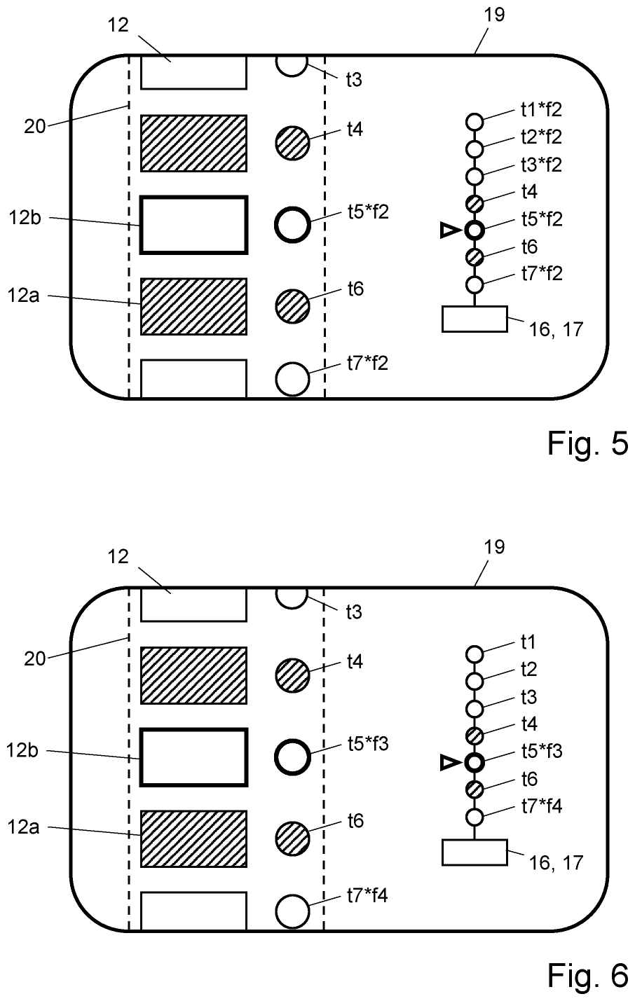

FIG. 5 The user interface for explaining a second configuration variant of the food processor according to the invention,

FIG. 6 The user interface for explaining a third configuration variant of the food processor according to the invention,

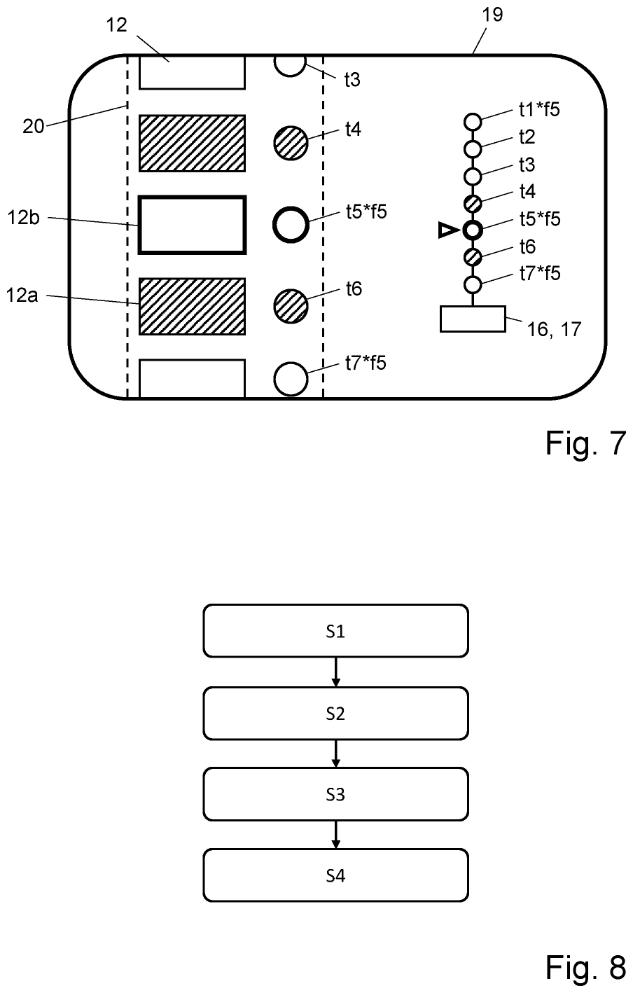

FIG. 7 The user interface for explaining a fourth configuration variant of the food processor according to the invention, and

FIG. 8A flow chart for explaining a food preparation method according to the invention according to one embodiment.

FIG. 1 shows a food processor 10 having a user interface 19 comprising a screen for displaying information and, in particular, for displaying a recipe 11 comprising multiple preparation steps/stages. The food processor 10 further comprises a preparation vessel 20 for preparing food and a lid 21 for covering an opening of the preparation vessel 20. The preparation vessel 20 is inserted into a holder 22 of the food processor 10. The preparation vessel 20 includes a handle 23 to allow the preparation vessel 20 to be removed from the holder 22 as easily as possible. The food processor 10 further comprises a closing mechanism 24 for closing the preparation vessel 20 or for pressing the lid 21 against the preparation vessel 20.

The user interface 19 is configured to display a digital user menu on the screen of the user interface 19. The screen is preferably touch sensitive, for example to allow operating parameters to be set by touching the screen. The screen serves as an input and output device. The food processor 10 may comprise a rotary and/or push button 25 as an additional input device, which may also be used to set one or multiple operating parameters, for example new target working times, in interaction with the digital user menu.

The food processor 1 also has a schematically shown profile memory 18 and a schematically shown control device 13 with a processor. The control device 13 can access the digital recipe 11 for food preparation, so that the food processor 10 and possibly other kitchen appliances are operated as defined in the preparation steps/stages of the recipe 11.

In FIG. 2, a computer-readable and non-volatile storage medium 15 in the form of a memory stick or flash drive is shown. A computer program product 14 is installed on the storage medium 15, which can be executed and/or installed in the food processor 10 for food preparation using the food processor 10 shown in FIG. 1.

With reference to FIGS. 3 to 8, various configuration variants of the food processor 10 are then explained. The configuration variants are not exhaustive and may be or may be implemented simultaneously or jointly in the food processor 10. FIG. 3 shows a screen of a user interface 19 of a food processor 10 according to a conventional configuration. As shown in FIG. 3, the screen displays the recipe 11 with different preparation steps/stages 12, 12a. Autonomous preparation steps/stages 12a, which can be performed by the food processor 10 itself, i.e. which do not require any additional action by the user, are shown shaded. Autonomous preparation steps/stages 12a have a fixed duration that cannot be influenced by the speed of the user. Manual or at least partially manual preparation steps/stages, for which the target working times are determined in the example shown, are shown as simple boxes. Active preparation steps/stages 12b or manual active preparation steps/stages 12b which the user is currently executing or should execute are outlined in bold in the example shown. In addition to the various preparation steps/stages 12, 12a, an associated or preparation step/stage-specific target working time t1-t7 is displayed in each case. In addition to the recipe 11, a time overview with all target working times t1-t7 is also displayed. At the bottom of the time overview, an end time 16 for food preparation and a remaining time duration 17 until the end time 16 is reached are displayed in the example shown.

FIG. 4 illustrates a user interface 19 for explaining a first configuration variant of the food processor 10. According to the configuration variant shown in FIG. 4, the food processor 10 is configured and adapted for electronically accessing the recipe 11 and for processing the recipe 11 to perform a food preparation comprising multiple preparation steps/stages 12. Further, the food processor 10 is configured and adapted to execute comparisons between target working times t1-t3, t5, 17 specified in the recipe 11 for performing the manual preparation steps/stages 12 and actual working times actually required by the user of the food processor 10 for performing the manual preparation steps/stages 12. Further, the food processor 10 is configured and adapted to determine a speed factor f1 with respect to a working speed of the user based on the comparisons executed. According to the example shown in FIG. 4, the speed factor f1 is determined based on comparisons between the target working times t1-t3 and the actual working times during the first three manual preparation steps/stages 12. The food processor 10 is now further configured and adapted in such a way that the future target working times required manually or by the user for performing the corresponding future manual preparation steps/stages 12 are determined on the basis of the predetermined target working time t5, t7 and on the basis of the determined speed factor f1 and are displayed accordingly on the screen of the user interface 19. For this purpose, the following specified target working times t5, t7 are multiplied by the determined speed factor f1.

In the manner described above, it is now possible to dynamically adjust the end time 16 of food preparation and/or the remaining time duration 17 until the end time 16 is reached during food preparation on the basis of the speed factor f1 and/or on the basis of the determined future target working times and to display this to the user accordingly. The future target working times are thus determined during food preparation and are also displayed perceptibly to the user during food preparation.

FIG. 5 shows a user interface 19 for explaining a second configuration variant of the food processor 10, in which the food processor is configured and adapted in such a way that an average speed factor f2 with respect to an average working speed of the user is determined on the basis of the comparisons, and the future target working times for performing the future manual preparation steps/stages 12 are determined on the basis of the predetermined target working times and on the basis of the determined average speed factors f2, and are then displayed on the screen of the user interface 19. As shown in FIG. 4, the target working times t1-t3, t5, t7 originally specified in the recipe for manually performing the corresponding preparation steps/stages 12 each multiplied by the average speed factor f2.

FIG. 6 shows a user interface 19 for explaining a third configuration variant of the food processor 10, in which the food processor 10 is configured and adapted in such a way that, on the basis of the comparisons, different specific speed factors f3, f4 are determined with respect to a respective working speed for different manual preparation steps/stages 12, and future target working times t5, t7 for performing the associated preparation steps/stages 12 are determined on the basis of the specific speed factors f3, f4 and are then displayed on the screen of the user interface 19. In the example shown, the fifth target working time is multiplied by a specific speed factor f3 and the seventh target working time t7 is multiplied with another or different specific speed factor f4.

FIG. 7 shows a user interface 19 for explaining a fourth configuration variant of the food processor 10, in which the food processor 10 is configured and adapted such that different speed factors f1, f5 (only speed factor f5 shown in FIG. 7) of different users are assigned to a respective user profile in the profile memory 18 and future target working times are determined on the basis of a user-specific speed factor f5 from the user profile used for food preparation. Of course, the food processor could also be configured and adapted in such a way that multiple different speed factors per user profile can be created and used instead of the one speed factor f5.

FIG. 8 shows a flow chart for explaining an embodiment variant of a method for food preparation using the above-described food processor 10. For this purpose, in a step/stage S1, a digital recipe 11 is accessed electronically and processed electronically accordingly for performing the food preparation with multiple preparation steps/stages 12, 12a. In a step/stage S2, comparisons are made between target working times t1-t3, t5, 17 specified in the recipe 11 for performing the manual preparation steps/stages 12 and actual working times actually required by a user of the food processor 10 for performing the manual preparation steps/stages 12. At this point, it should be mentioned that the method steps/stages described herein do not have to be performed in the sequence shown. Steps/stages S1 and S2 can, for example, also be carried out partially simultaneously. In a step/stage S3, as shown for example in FIG. 4, a speed factor f1 with respect to a working speed of the user is determined on the basis of the comparisons performed. Subsequently, in a step/stage S4, future target working times for performing future manual preparation steps/stages 12 are determined on the basis of the originally specified target working times t5, t7 and the determined speed factor f1.

In the following table, the method according to the invention (for food preparation) is shown according to a further embodiment for explanation.

TABLE

| | | Initial | New | |
|---|---|---|---|---|
| | | target | actual | |
| Preparation | Step/stage - | Working | Working | |
| step/stage | Type | time | time | Time |
| Preheat oven | Manual | 120 | 132 | 12:02:12 |
| | | Seconds | Seconds | |
| Grease baking | Manual | 180 | 198 | 12:05:30 |
| pan | | Seconds | Seconds | |
| Place | Manual | 480 | 528 | 12:10:18 |
| ingredients in | | Seconds | Seconds | |
| mixing bowl | | | | |
| Kneading in | | 180 | 180 | 12:13:18 |
| the mixing | | Seconds | Seconds | |
| bowl for 3 | | | | |
| minutes | | | | |
| Form dough on | Manual | 180 | 198 | 12:16:36 |
| work surface | | Seconds | Seconds | |
| and then place | | | | |
| in baking pan | | | | |
| Bake for 60 | Machine | 3.600 | 3.600 | 13:16:36 |
| minutes at | | Seconds | Seconds | |
| 200 degrees | | | | |
| Turn bread | Manual | 180 | 198 | 13:19:54 |
| out onto wire | | Seconds | Seconds | |
| rack, let cool | | | | |
| and cut into | | | | |
| slices | | | | |
| Total | | 1 hour | 1 hour | |
| | | 15 minutes | 19 minutes | |
| | | | 54 seconds | |

With reference to the table shown above, an example of the method described in FIG. 8 is described in further detail using a speed factor of 1.1. In a first preparation step/stage to be carried out manually, an oven must first be preheated. For this, an initial target working time of 120 seconds would be specified, whereby the initial target working time is extended by 10% using the speed factor, so that a new or correspondingly modified target working time of 132 seconds is determined. Based on a current time and the new target working time, the expected end time until completion of the first preparation step/stage is also determined. The end time or time may be displayed on the screen of the user interface 19. The procedure explained with reference to the first step/stage is then also carried out for the further manual preparation steps/stages. The new or changed target working times are also used to determine a new total working time, which in turn is used to determine the expected end time of the food preparation.

The invention admits of further configuration principles in addition to the embodiments illustrated. That is, the invention is not to be considered limited to the embodiments explained with reference to the figures.

### LIST OF REFERENCE SIGNS

10 Food processor
11 Recipe
12 Manual preparation step/stage
12a Autonomous preparation step/stage
12b Active preparation step/stage
13 Control device
14 Computer program product
15 Storage medium
16 End time
17 Remaining time duration
18 Profile memory
19 User interface
20 Preparation vessel
21 Lid
22 Holder
23 Handle
24 Closing mechanism
25 Push button/Rotary Button

1. A food processor configured and adapted to:
electronically accessing a recipe and processing the recipe to perform a food preparation comprising multiple preparation stages,
performing comparisons between target working times specified in the recipe for performing the preparation stages and actual working times actually required by a user of the food processor for performing the preparation stages,
determining at least one speed factor relating to a working speed of the user on the basis of the comparisons made, and
determining at least one future target working time for performing at least one future preparation stage on the basis of a predetermined target working time and the at least one determined speed factor.

2. The food processor according to claim 1, which is configured and adapted in such a way that, on the basis of at least the at least one speed factor or on the basis of the at least one determined future target working time, at least an end time of the food preparation or a remaining time duration until the end time is reached are determined and displayed perceptibly for the user.

3. The food processor according to claim 1, configured and adapted at least to determine the at least one future target working time during food preparation or to display the at least one future target working time perceptibly to the user during food preparation.

4. The food processor according to claim 1, configured and adapted to determine the future target working time for performing a future manual preparation stage.

5. The food processor according to claim 1, configured and adapted to determine an average speed factor with respect to an average working speed of the user based on the comparisons, and to determine the at least one future target working time for performing the at least one future preparation stage based on a predetermined target working time and the determined average speed factor.

6. The food processor according to claim 1, configured and adapted such that different specific speed factors with respect to a respective working speed for different preparation stages are determined based on the comparisons, and the at least one future target working time for performing the at least one future preparation stage is determined based on a specific speed factor.

7. The food processor according to claim 1, comprising a profile memory for storing different user profiles of different users of the food processor, wherein the food processor is configured and adapted such that different speed factors of different users are assigned to the respective user profile and the at least one future target working time is determined on the basis of at least one user-specific speed factor from the user profile used for food preparation.

8. A method of food preparation using a food processor according to claim 1, comprising:
electronically accessing a recipe and processing the recipe to perform food preparation with multiple preparation stages,
performing comparisons between target working times specified in the recipe for performing the preparation stages and actual working times actually required by a user of the food processor for performing the preparation stages,
determining at least one speed factor relating to a working speed of the user on the basis of the comparisons made, and
determining at least one future target working time for performing at least one future preparation stage on the basis of a predetermined target working time and the at least one determined speed factor.

9. The method according to claim 8, wherein at least an end time of the food preparation or a remaining time duration until the end time is reached are determined and displayed perceptibly for the user on the basis of at least the at least one speed factor (f1; f2; f3, f4; f5) or on the basis of the at least one determined future target working time.

10. The method according to claim 8, wherein the at least one future target working time is at least determined during food preparation or is displayed perceptibly to the user during food preparation.

11. The method according to claim 8, wherein an average speed factor is determined with respect to an average working speed of the user based on the comparisons, and the at least one future target working time for performing the at least one future preparation stage is determined based on a predetermined target working time and the determined average speed factor.

12. The method according to claim 8, wherein different specific speed factors with respect to a respective working speed for different preparation stages are determined on the basis of the comparisons, and the at least one future target working time for performing the at least one future preparation stage is determined on the basis of a specific speed factor.

13. The method according to claim 8, wherein different speed factors of different users are assigned to a respective user profile stored in the food processor and the at least one future target working time is determined on the basis of at least one user-specific speed factor from the user profile used for food preparation.

14. A computer program product comprising instructions that, when the computer program product is executed by a computer, cause the computer to execute the method according to claim 8.

15. A computer readable storage medium having a computer program product stored thereon according to claim 14.
